(19) United States
(12) Patent Application Publication
(10) Pub. No.: US 2022/0360617 A1
(43) Pub. Date: Nov. 10, 2022

(54) TRANSMISSION OF A REPRESENTATION OF A SPEECH SIGNAL

(71) Applicant: Telefonaktiebolaget LM Ericsson (publ), Stockholm (SE)

(72) Inventors: Peter ÖKVIST, LULEÅ (SE); Tommy ARNGREN, SÖDRA SUNDERBYN (SE); Tomas FRANKKILA, LULEÅ (SE)

(21) Appl. No.: 17/641,348

(22) PCT Filed: Sep. 10, 2019
(86) PCT No.: PCT/EP2019/074110

§ 371 Date: Mar. 8, 2022

(51) Int. Cl. H04L 65/75; H04L 65/80; G10L 25/60; G10L 15/26

(52) U.S. Cl. CPC H04L 65/75; H04L 65/80; G10L 25/60; G10L 15/26

(57) ABSTRACT

There are provided mechanisms for transmitting a representation of a speech signal to a second terminal device. A method is performed by a first terminal device. The method includes obtaining a speech signal to be transmitted to the second terminal device. The method includes obtaining an indication of whether to, when encoding the speech signal into the representation, convert the speech signal to a text signal or not before transmission to the second terminal device. The indication is based on information of local ambient background noise at the first terminal device and of current network conditions between the first terminal device and the second terminal device. The method includes encoding the speech signal into the representation of the speech signal as determined by the indication. The method includes transmitting the representation of the speech signal towards the second terminal device.

### TECHNICAL FIELD

Embodiments presented herein relate to a method, a first terminal device, a computer program, and a computer program product for transmitting a representation of a speech signal to a second terminal device. Further embodiments presented herein relate to a method, a second terminal device, a computer program, and a computer program product for receiving a representation of a speech signal from a first terminal device. Further embodiments presented herein relate to a method, a network node, a computer program, and a computer program product for handling transmission of a representation of a speech signal from a first terminal device to a second terminal device.

### BACKGROUND

Automatic speech recognition (ASR) systems are commonly used to, at a device, receive speech from a user and interpret the content of that speech such that a text-based representation of that speech is outputted at the device. For example, ASR systems have been used to initially handle incoming telephone calls at a central facility. By interpreting the spoken commands received from those callers, the ASR system can be used to respond to those callers or direct them to an appropriate department or service. ASR systems used in such scenarios are often tuned to receive speech that differs in quality. Some users might place a call from a quiet room using a high-quality phone connection whilst other users might place a call from a noisy street with a telephone connection having low signal to noise ratio.

Several solutions exist for the estimation of the sound quality, a few examples of which will be mentioned next.

The ITU-T E-model, defined by “G.107 : The E-model: a computational model for use in transmission planning” as approved on 29 Jun. 2015 and issued by the International Telecommunication Union, describes a method for combining several types of impairments (codec, frame erasures, noise (sender), noise (receiver), etc.) into a so called “R score”, which describes the overall quality.

Formal subjective evaluation methods can be used in listening-only tests to evaluate the sound quality without considering the effects of delay. These methods resulting in a Mean Opinion Score (MOS) or Differential Mean Opinion Score (DMOS). Examples of such methods are the absolute category rating (ACR) listening-only test and the Degradation Category Rating (DCR) test (see for example ITU-T Recommendation P.800 “Methods for subjective determination of transmission quality”).

Other formal subjective evaluation methods can be used in conversation tests to evaluate the conversational quality, which includes both the effects of the sound quality and the delay in the conversation (see for example ITU-T Recommendation P.804 “Subjective diagnostic test method for conversational speech quality analysis”). These methods also give a quality score, e.g. in the form of a MOS. These methods may also be used to evaluate other effects of the conversation, for example listening effort and fatigue.

Objective models exist that estimate the subjective quality, e.g. Perceptual Evaluation of Speech Quality (PESQ) based tests (see for example ITU-T Recommendation P.862 “Perceptual evaluation of speech quality (PESQ): An objective method for end-to-end speech quality assessment of narrow-band telephone networks and speech codecs”) and Perceptual Evaluation of Audio Quality (PEAQ) tests (see for example ITU-R Recommendation BS.1387 “Method for objective measurements of perceived audio quality”). Some of these methods result in a quality score in the form of a MOS.

The Speech Quality Index (SQI) can be used in cellular systems for continuous performance monitoring of individual speech calls (see for example A. Karlsson et. al., “Radio link parameter based speech quality index-SQI”, 1999 IEEE Workshop on Speech Coding Proceedings. Model, Coders, and Error Criteria). Different types of scales can be used but the most common are a 5-point scale, similar to a MOS.

Mechanisms often exist in telecommunication systems for reporting performance metrics related to the sound quality. Such mechanisms might be used for performance monitoring but sometimes also for adapting the transmission. For example, the transmission might be adapted in terms of bit rate adaptation, either by adapting the bit rate of the speech encoding or by adapting the packet rate.

However, there is still a need for improved mechanisms for transmitting a speech signal between a transmitting terminal device and a receiving terminal device.

### SUMMARY

An object of embodiments herein is to provide efficient mechanisms for transmitting a speech signal between a transmitting terminal device and a receiving terminal device.

According to a first aspect there is presented a method for transmitting a representation of a speech signal to a second terminal device. The method is performed by a first terminal device. The method comprises obtaining a speech signal to be transmitted to the second terminal device. The method comprises obtaining an indication of whether to, when encoding the speech signal into the representation, convert the speech signal to a text signal or not before transmission to the second terminal device. The indication is based on information of local ambient background noise at the first terminal device and of current network conditions between the first terminal device and the second terminal device. The method comprises encoding the speech signal into the representation of the speech signal as determined by the indication. The method comprises transmitting the representation of the speech signal towards the second terminal device.

According to a second aspect there is presented a first terminal device for transmitting a representation of a speech signal to a second terminal device. The first terminal device comprises processing circuitry. The processing circuitry is configured to cause the first terminal device to obtain a speech signal to be transmitted to the second terminal device. The processing circuitry is configured to cause the first terminal device to obtain an indication of whether to, when encoding the speech signal into the representation, convert the speech signal to a text signal or not before transmission to the second terminal device. The indication is based on information of local ambient background noise at the first terminal device and of current network conditions between the first terminal device and the second terminal device. The processing circuitry is configured to cause the first terminal device to encode the speech signal into the representation of the speech signal as determined by the indication. The processing circuitry is configured to cause the first terminal device to transmit the representation of the speech signal towards the second terminal device.

According to a third aspect there is presented a computer program for transmitting a representation of a speech signal to a second terminal device. The computer program comprises computer program code which, when run on processing circuitry of a first terminal device, causes the first terminal device to perform a method according to the first aspect.

According to a fourth aspect there is presented a method for receiving a representation of a speech signal from a first terminal device. The method is performed by a second terminal device. The method comprises obtaining the representation of the speech signal from the first terminal device. The method comprises obtaining an indication of how to play out the speech signal. The indication is based on information of local ambient background noise at the second terminal device and of current network conditions between the first terminal device and the second terminal device. The method comprises playing out the speech signal in accordance with the indication.

According to a fifth aspect there is presented a second terminal device for receiving a representation of a speech signal from a first terminal device. The second terminal device comprises processing circuitry. The processing circuitry is configured to cause the second terminal device to obtain the representation of the speech signal from the first terminal device. The processing circuitry is configured to cause the second terminal device to obtain an indication of how to play out the speech signal. The indication is based on information of local ambient background noise at the second terminal device and of current network conditions between the first terminal device and the second terminal device. The processing circuitry is configured to cause the second terminal device to play out the speech signal in accordance with the indication.

According to a sixth aspect there is presented a computer program for receiving a representation of a speech signal from a first terminal device. The computer program comprises computer program code which, when run on processing circuitry of a second terminal device, causes the second terminal device to perform a method according to the fourth aspect.

According to a seventh aspect there is presented a method for handling transmission of a representation of a speech signal from a first terminal device to a second terminal device. The method is performed by a network node. The method comprises obtaining an indication that the speech signal is to be transmitted from the first terminal device to the second terminal device. The method comprises obtaining an indication of whether the first terminal device is to, when encoding the speech signal into the representation, convert the speech signal to a text signal or not before transmission to the second terminal device. The indication is based on information of current network conditions between the first terminal device and the second terminal device and at least one of local ambient background noise at the first terminal device and local ambient background noise at the second terminal device. The method comprises providing the indication of whether the first terminal device is to convert the speech signal to a text signal or not before transmission to the second terminal device to the first terminal device.

According to an eight aspect there is presented a network node for handling transmission of a representation of a speech signal from a first terminal device to a second terminal device. The network node comprises processing circuitry. The processing circuitry is configured to cause the network node to obtain an indication that the speech signal is to be transmitted from the first terminal device to the second terminal device. The processing circuitry is configured to cause the network node to obtain an indication of whether the first terminal device is to, when encoding the speech signal into the representation, convert the speech signal to a text signal or not before transmission to the second terminal device. The indication is based on information of current network conditions between the first terminal device and the second terminal device and at least one of local ambient background noise at the first terminal device and local ambient background noise at the second terminal device. The processing circuitry is configured to cause the network node to provide the indication of whether the first terminal device is to convert the speech signal to a text signal or not before transmission to the second terminal device to the first terminal device.

According to a ninth aspect there is presented a computer program for handling transmission of a representation of a speech signal from a first terminal device to a second terminal device, the computer program comprising computer program code which, when run on processing circuitry of a network node, causes the network node to perform a method according to the seventh aspect.

According to a tenth aspect there is presented a computer program product comprising a computer program according to at least one of the third aspect, the sixth aspect, and the tenth aspect and a computer readable storage medium on which the computer program is stored. The computer readable storage medium can be a non-transitory computer readable storage medium.

Advantageously these methods, these terminal devices, these network nodes, and these computer programs enable efficient transmission of a speech signal between a transmitting terminal device (as defined by the first terminal device) and a receiving terminal device (as defined by the second terminal device).

Advantageously these methods, these terminal devices, these network nodes, and these computer programs enable robust communication and alternative modes of communication depending on network conditions and ambient background noise conditions.

Advantageously these methods, these terminal devices, these network nodes, and these computer programs allow for fallback in case the speech becomes unintelligible.

Advantageously these methods, these terminal devices, these network nodes, and these computer programs are backwards compatibility with legacy devices. For example, any conversion of the speech signal to a text signal might be implemented, or performed, at any of the first terminal device, the second terminal device, or the network node.

Advantageously these methods, these terminal devices, these network nodes, and these computer programs enable negotiation between the terminal devices and/or the network node about which functionality that should be performed in each respective terminal device and/or network node. Such negotiation mechanisms can be used to enable or disable the speech to text conversion to, for example, handle different user preferences or to handle backwards compatibility if any of the terminal devices does not support the required functionality.

Advantageously these methods, these terminal devices, these network nodes, and these computer programs offer flexibility for how the speech to text conversion functionality is used by different second terminal device receiving the representation of the speech signal with regards to how to play out the speech signal (either as audio or text).

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3, and 4 are flowcharts of methods according to embodiments;

FIG. 5 is a schematic diagram showing functional units of a terminal device according to an embodiment;

FIG. 6 is a schematic diagram showing functional modules of a terminal device according to an embodiment;

FIG. 7 is a schematic diagram showing functional units of a network node according to an embodiment;

FIG. 8 is a schematic diagram showing functional modules of a network node according to an embodiment; and

FIG. 9 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

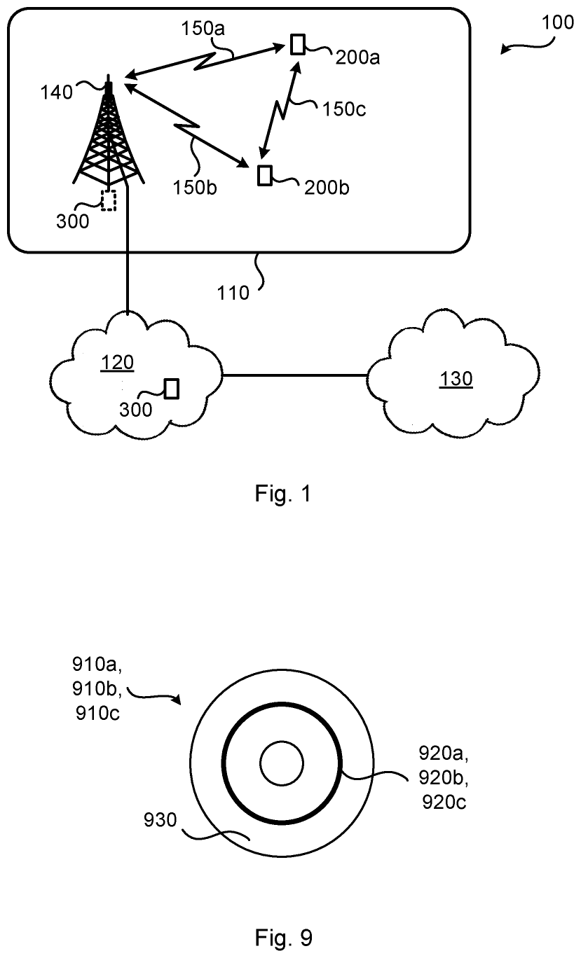

FIG. 1 is a schematic diagram illustrating a communication network 100 where embodiments presented herein can be applied. The communication network 100 comprises a transmission and reception point (TRP) 140 serving terminal devices 200a, 200b over wireless links 150a, 150b in a radio access network 110. Alternatively, the terminal devices 200a, 200b communicate directly with each other over a link 150c. The TRP 140 is operatively connected to a core network 120 which in turn is operatively connected to a service network 130. The terminal devices 200a, 200b are thereby enabled to access services of, and exchange data with, the service network 130. The TRP 140 is controlled by a network node 300. The network node 300 might be collocated with, integrated with, or part of, the TRP 140, which in combination could be a radio base station, base transceiver station, node B, evolved node B (eNB), NR base station (gNB), access point, or access node. In other examples the network node 300 is physically separated from the TRP 140. For example, the network node 300 might be located in the core network 120. In some examples the network node 300 is configured to handle speech signals, such as any of: converting an encoded speech signal to a text signal, converting a decoded speech signal to a text signal, storing a text signal, storing the encoded speech signal, etc. Although only a single TRP 140 is illustrated in FIG. 1, the skilled person would understand that the radio access network 100 might comprise a plurality of TRPs each configured to serve a plurality of terminal devices, and that that the terminal devices 200a, 200b need not to be served by one and the same TRP. Each terminal device 200a, 200b could be a portable wireless device, mobile station, mobile phone, handset, wireless local loop phone, user equipment (UE), smartphone, laptop computer, tablet computer, or the like.

As noted above there is a need for efficient transmission of a speech signal between a transmitting terminal device (as defined by the first terminal device 200a) and a receiving terminal device (as defined by the second terminal device 200b).

In more detail, high ambient noise levels impair communications, especially for users of terminal devices; irrespectively of a caller being in a location with good or excellent network conditions, a high level of ambient background noise impairs the cellular speech quality. Ambient background noise could arise from both sides of a communication link, i.e. both at the first terminal device 200a as used by the speaker and at the second terminal device 200b as used by the listener. Noise cancellation might at the first terminal device 200a (or even at the network node 300) be used to minimize the amount of noise the speech encoder at the first terminal device 200a is to handle. However, this would not help if ambient background noise is experienced by the listener at the second terminal device 200b.

In some locations where the network conditions are poor, radio links might start to deteriorate; at some certain frame error rate (FER) or packet loss ratio (PLR) packets are lost which will result in that the speech quality at the second terminal device 200b will deteriorate such that the spoken communication as played out at the second terminal device 200b no longer holds acceptable quality or even is unintelligible. Thus, at a location where the ambient noise level at the first terminal device 200a is low, the speech quality at the second terminal device 200b might still be poor.

In another scenario a high level of ambient noise is experienced at the first terminal device 200a and the network conditions are poor, thus resulting in that the intended information transfer is even more difficult to interpret for the user of the second terminal device 200b.

In a yet further scenario, a high level of ambient noise is experienced at both the first terminal device 200a and the second terminal device 200b and the network conditions are poor, thus resulting in that the intended information transfer is yet even more difficult to interpret for the user of the second terminal device 200b.

In summary, the quality is a function of ambient noise level at the first terminal device 200a, network conditions, and ambient noise level at the second terminal device 200b.

The embodiments disclosed herein thus relate to mechanisms for handling these issues. In order to obtain such mechanisms there is provided a first terminal device 200a, a method performed by the first terminal device 200a, a computer program product comprising code, for example in the form of a computer program, that when run on processing circuitry of the first terminal device 200a, causes the first terminal device 200a to perform the method. In order to obtain such mechanisms there is further provided a second terminal device 200b, a method performed by the second terminal device 200b, and a computer program product comprising code, for example in the form of a computer program, that when run on processing circuitry of the second terminal device 200b, causes the second terminal device 200b to perform the method. In order to obtain such mechanisms there is further provided a network node 300, a method performed by the network node 300, and a computer program product comprising code, for example in the form of a computer program, that when run on processing circuitry of the network node 300, causes the network node 300 to perform the method.

The herein disclosed mechanisms enable dynamic triggering of speech-to-text (or lip read to text) based on the local ambient background noise level at the first terminal 200a, at the second terminal device 200b, or at both the first terminal device 200a and the second terminal device 200b, as well as current network conditions.

According to the herein disclosed mechanisms, local ambient background noise level and/or network conditions can be used for different types triggers and ways of mitigation by each individual terminal device 200a, lob as well as by a network node 300 in the network 100.

The herein disclosed mechanisms enable coordination of the triggering of speech-to-text (or lip reading) to handle cases where the sources of the impairments occur at different locations, e.g. a high level of local ambient background noise experienced at the first terminal device 200a and poor network conditions experienced at the second terminal device 200b or vice versa.

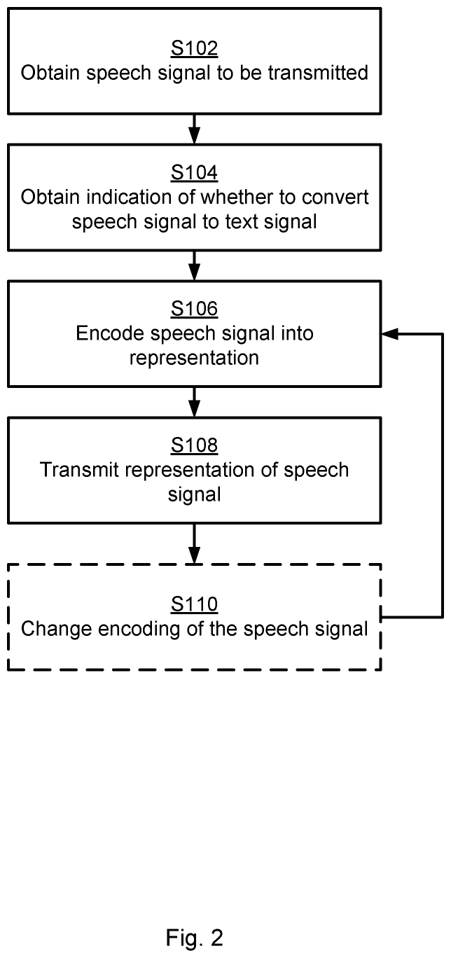

Reference is now made to FIG. 2 illustrating a method for transmitting a representation of a speech signal to a second terminal device 200b as performed by the first terminal device 200a according to an embodiment.

S102: The first terminal device 200a obtains a speech signal to be transmitted to the second terminal device 200b.

S104: The first terminal device 200a obtains an indication of whether to, when encoding the speech signal into the representation, convert the speech signal to a text signal or not before transmission to the second terminal device 200b. The indication is based on information of local ambient background noise at the first terminal device 200a and of current network conditions between the first terminal device 200a and the second terminal device 200b.

The first terminal device 200a is in S104 thus made aware of local ambient background noise at the first terminal device 200a and of current network conditions between the first terminal device 200a and the second terminal device 200b. The information of local ambient background noise at the first terminal device 200a is typically obtained by measurements of the local ambient background noise, or other actions, being performed locally at the first terminal device 200a. However, such measurements, or actions, might alternatively be performed elsewhere, such as by the network node 300 or even by the second terminal device 200b. Likewise, the current network conditions between the first terminal device 200a and the second terminal device 200b might be obtained through measurements, or other actions, performed locally at the first terminal device 200a, or be obtained as a result of measurements, or actions, performed elsewhere, such as by the network node 300 or by the second terminal device 200b. Further aspects relating thereto will be disclosed below.

S106: The first terminal device 200a encodes the speech signal into the representation of the speech signal as determined by the indication.

This does not exclude that the speech signal also is encoded into another representation, just that the speech signal at least is encoded to the representation determined by the indication. Further aspects relating thereto will be disclosed below.

S108: The first terminal device 200a transmits the representation of the speech signal towards the second terminal device 200b.

If the speech signal also is encoded into another representation, also this another representation of the speech signal is transmitted towards the second terminal device 200b.

Embodiments relating to further details of methods for transmitting a representation of a speech signal to a second terminal device 200b as performed by the first terminal device 200a will now be disclosed.

In some embodiments the speech signal is only converted to a text signal (i.e., not to an encoded speech signal) and thus the representation of the speech signal transmitted towards the second terminal device 200b only comprises the text signal.

The text signal might be transmitted using less radio-quality sensitive radio access bearers than if encoded speech were to be transmitted. The bearer for the text signal might, for example, user more retransmissions, spread out the transmission over time, or delay the transmission until the network conditions improve. This is possible since text is less sensitive to end-to-end delays compared to speech. Further, the text signal might be transmitted at a lower bitrate than encoded speech. For the same bit budget this allows for application of more resource demanding forward error correction (FEC) and/or automatic repeat request (ARQ) for increased resilience against poor network conditions.

In some embodiments, the speech signal is only encoded to an encoded speech signal when the indication is to not convert the speech signal to the text signal before transmission. However, in other embodiments, the speech signal is encoded to an encoded speech signal regardless if the encoding involves converting the speech signal to the text signal or not. The representation might then comprise both the text signal and the encoded speech signal of the speech signal such that the text signal and the encoded speech signal are transmitted in parallel.

In some embodiments the information of which the indication is based is represented by a total speech quality measure (TSQM) value, and the representation of the speech signal is determined to be the text signal when the TSQM value is below a first threshold value and otherwise to be an encoded speech signal of the speech signal. Further aspects relating thereto will be disclosed below. Additionally, as the skilled person understands, there could be other metrics used than TSQM where, as necessary, the conditions of actions depending on whether a value is below or above a threshold value are reversed. This is for example the case for a metric based on distortion, where a low level of distortion generally yields higher audio quality than a high level of distortion. Hence, although TSQM is used below the skilled person would understand how to modify the examples if other metrics were to be used.

In some embodiments the information is represented by a first total speech quality measure value (denoted TSQM1), and a second total speech quality measure value (denoted TSQM2), where TSQM1 represents a measure of the local ambient background noise at the first terminal device 200a and of the current network conditions between the first terminal device 200a and the second terminal device 200b, and TSQM2 represents a measure of local ambient background noise at the second terminal device 200b and of the current network conditions between the first terminal device 200a and the second terminal device 200b. The representation of the speech signal might then be determined to be the text signal when TSQM1 is more than a second threshold value larger than TSQM2 and otherwise to be an encoded speech signal of the speech signal. Further aspects relating thereto will be disclosed below.

As disclosed above, there might be different ways for the first terminal device 200a to be made aware of local ambient background noise at the first terminal device 200a and of current network conditions between the first terminal device 200a and the second terminal device 200b. In this respect, in some embodiments the indication is obtained by being determined by the first terminal device 200a. That is in some examples the measurements, or other actions, are performed locally by the first terminal device 200a.

In other embodiments the indication is obtained by being received from the second terminal device 200b or from a network node 300 serving at least one of the first terminal device 200a and the second terminal device 200b. That is in some examples the measurements, or other actions, are performed remotely by the network node 300 or the second terminal device 200b.

In some embodiments the indication is further based on information of local ambient background noise at the second terminal device 200b. As will be further disclosed below, the information of local ambient background noise at the second terminal device 200b might be determined locally by the second terminal device 200b, by the network node 300, or even locally by the first terminal device 200a.

There could be different ways for the first terminal device 200a to obtain the indication from the network node 300 or the second terminal device 200b. In some embodiments the indication is received in a Session Description Protocol (SDP) message. There could be different types of SDP messages that could be used for sending the indication to the first terminal device 200a. In some embodiments, the SDP message is an SDP offer with an attribute having a binary value defining whether to convert the speech signal to a text signal or not. As an example, the SDP message could be an SDP offer with attribute ‘a=TranscriptionON’ or ‘a=TranscriptionOFF’. Further aspects relating thereto will be disclosed below.

In general terms, the representation of the speech signal is transmitted during a communication session between the first terminal device 200a and the second terminal device 200b. In some aspects the local ambient background noise at the first terminal device 200a and/or at the second terminal device 200b and/or the network conditions change during the communication session. This might trigger the encoding of the speech signal to change during the communication session. Hence, according to an embodiment, the first terminal device 200a is configured to perform (optional) step S110:

S110: The first terminal device 200a changes the encoding of the speech signal during the communication session. Step S106 is then entered again.

That is, if S106 the speech signal is converted to a text signal before transmission to the second terminal device 200b, then in S110 the encoding is changed so that the speech signal is not converted to a text signal before transmission to the second terminal device 200b, and vice versa.

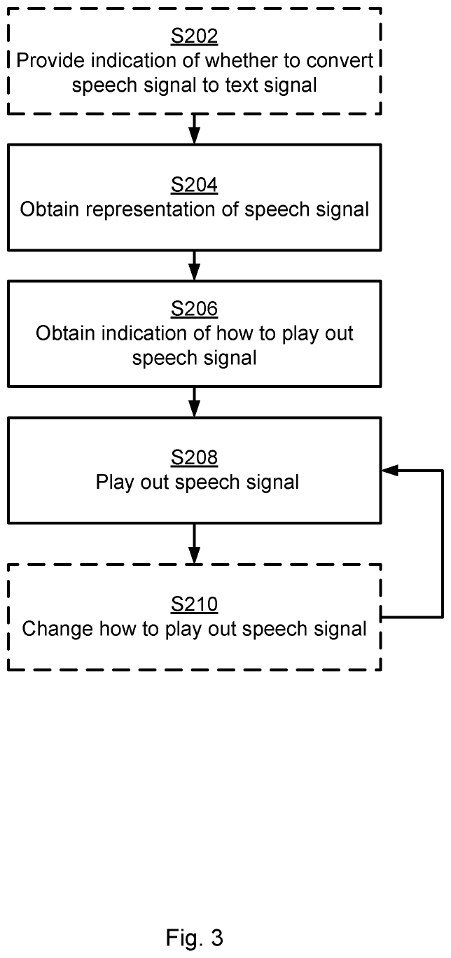

Reference is now made to FIG. 3 illustrating a method for receiving a representation of a speech signal from a first terminal device 200a as performed by the second terminal device 200b according to an embodiment.

S204: The second terminal device 200b obtains the representation of the speech signal from the first terminal device 200a.

S206: The second terminal device 200b obtains an indication of how to play out the speech signal. The indication is based on information of local ambient background noise at the second terminal device 200b and of current network conditions between the first terminal device 200a and the second terminal device 200b.

The information of local ambient background noise at the second terminal device 200b is typically obtained by measurements of the local ambient background noise, or other actions, being performed locally at the second terminal device 200b. However, such measurements, or actions, might alternatively be performed elsewhere, such as by the network node 300 or even by the first terminal device 200a. In short, any speech sent in the reverse direction (i.e., from the second terminal device 200b to the network node 300 and/or the first terminal device 200a) will include the local ambient background noise at the second terminal device 200b. The network node 300 and/or the first terminal device 200a could thus use this to estimate the local ambient background noise at the second terminal device 200b. Likewise, the current network conditions between the first terminal device 200a and the second terminal device 200b might be obtained through measurements, or other actions, performed locally at the second terminal device 200b, or be obtained as a result of measurements, or actions, performed elsewhere, such as by the network node 300 or by the first terminal device 200a. Further aspects relating thereto will be disclosed below.

S208: The second terminal device 200b plays out the speech signal in accordance with the indication.

Embodiments relating to further details of receiving a representation of a speech signal from a first terminal device 200a as performed by the second terminal device 200b will now be disclosed.

As above, in some embodiments the speech signal is only converted to a text signal (i.e., not to an encoded speech signal) and thus the representation of the speech signal obtained from the first terminal device 200a only comprises the text signal. As above, in some embodiments the representation of the speech signal is either a text signal or an encoded speech signal. Therefore, in some embodiments, the speech is played out either as audio or as text. However, in other embodiments the representation of the speech signal obtained from the first terminal device 200a comprises the text signal as well as an encoded speech signal and thus it might be up to the user of the second terminal device 200b to determine whether the second terminal device 200b is to play out the speech as audio only, as text only, or as both audio and text.

As above, there might be different ways for the second terminal device 200b to be made aware of local ambient background noise at the second terminal device 200b and of current network conditions between the first terminal device 200a and the second terminal device 200b. In this respect, in some embodiments the indication is obtained by being determined by the second terminal device 200b. That is in some examples the measurements, or other actions, are performed locally by the second terminal device 200b.

In other embodiments the indication is obtained by being received from the first terminal device 200a or from a network node 300 serving at least one of the first terminal device 200a and the second terminal device 200b.

In some embodiments the indication is further based on information of local ambient background noise at the first terminal device 200a. As has been disclosed above, the information of local ambient background noise at the first terminal device 200a might be determined locally by the first terminal device 200a, by the network node 300, or even locally by the second terminal device 200b.

In yet further embodiments the indication is further based on user input as received by the second terminal device 200b. In yet further embodiments the indication is further based on at least one capability of the second terminal device 200b to play out the speech signal.

There could be different ways for the second terminal device 200b to obtain the indication from the network node 300 or the first terminal device 200a. In some embodiments the indication is received in an SDP message.

As disclose above, the indication as obtained in S104 of whether the first terminal device 200a is to, when encoding the speech signal into the representation, convert the speech signal to a text signal or not before transmission to the second terminal device 200b might be provided by the second terminal device towards the first terminal device 200a. Hence, according to an embodiment, the second terminal device 200b is configured to perform (optional) step S202:

S202: The second terminal device 200b provides an indication to the first terminal device 200a of whether the first terminal device 200a is to, when encoding the speech signal into the representation, convert the speech signal to a text signal or not before transmission to the second terminal device 200b. The indication is based on information of local ambient background noise at the second terminal device 200b and of current network conditions between the first terminal device 200a and the second terminal device 200b.

There could be different ways for the second terminal device 200b to provide the indication in S202. In some embodiments the indication is provided in an SDP message.

As above, in general terms, the representation of the speech signal is transmitted during a communication session between the first terminal device 200a and the second terminal device 200b. As above, in some aspects the local ambient background noise at the first terminal device 200a and/or at the second terminal device 200b and/or the network conditions change during the communication session. This might trigger the play-out of the speech signal to change during the communication session. Hence, according to an embodiment, the second terminal device 200b is configured to perform (optional) step S210:

S210: The second terminal device 200b changes how to play out the speech signal during the communication session. Step S208 is then entered again.

In some aspects the first terminal device 200a and the second communication device 200b communicate directly with each other over a local communication link. However, in other aspects the first terminal device 200a and the second communication device 200b communicate with each via the network node 300. Aspects relating to the network node 300 will now be disclosed.

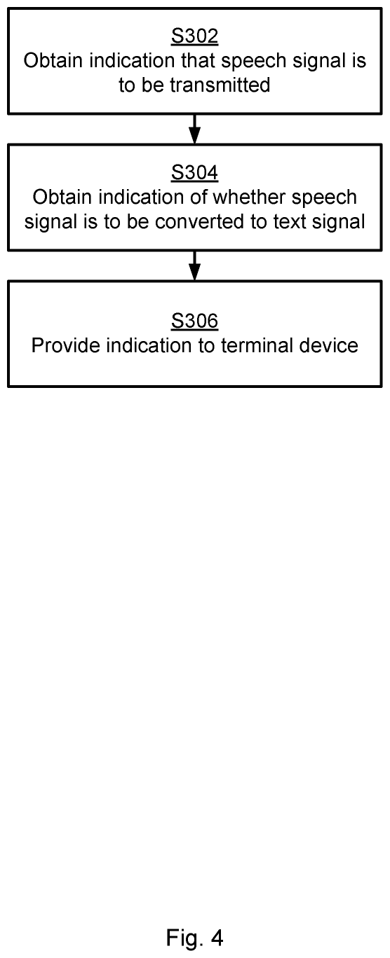

Reference is now made to FIG. 4 illustrating a method for handling transmission of a representation of a speech signal from a first terminal device 200a to a second terminal device 200b as performed by the network node 300 according to an embodiment.

It is in this embodiment assumed that the network node 300 is in communication with both the first terminal device 200a and the second terminal device 200b.

S302: The network node 300 obtains an indication that the speech signal is to be transmitted from the first terminal device 200a to the second terminal device 200b.

S304: The network node 300 obtains an indication of whether the first terminal device 200a is to, when encoding the speech signal into the representation, convert the speech signal to a text signal or not before transmission to the second terminal device 200b. The indication is based on information of current network conditions between the first terminal device 200a and the second terminal device 200b and at least one of local ambient background noise at the first terminal device 200a and local ambient background noise at the second terminal device 200b.

As above, the information of local ambient background noise at the first terminal device 200a is typically obtained by measurements of the local ambient background noise, or other actions, being performed locally at the first terminal device 200a. However, such measurements, or actions, might alternatively be performed elsewhere, such as by the network node 300 or even by the second terminal device 200b. Likewise, the information of local ambient background noise at the second terminal device 200b is typically obtained by measurements of the local ambient background noise, or other actions, being performed locally at the second terminal device 200b. However, such measurements, or actions, might alternatively be performed elsewhere, such as by the network node 300 or even by the first terminal device 200a. Likewise, the current network conditions between the first terminal device 200a and the second terminal device 200b might be obtained through measurements, or other actions, performed locally at any of the first terminal device 200a, the second terminal device 200b, or the network node 300.

S306: The network node 300 provides the indication of whether the first terminal device 200a is to convert the speech signal to a text signal or not before transmission to the second terminal device 200b from the first terminal device 200a.

Embodiments relating to further details of handling transmission of a representation of a speech signal from a first terminal device 200a to a second terminal device 200b as performed by the network node 300 will now be disclosed.

As above, in some embodiments the information is represented by a TSQM value, where the indication is that the representation of the speech signal is to be the text signal when the TSQM value is below a first threshold value and otherwise to be an encoded speech signal of the speech signal. Further aspects relating thereto will be disclosed below.

As above, in some embodiments the information is represented by a first total speech quality measure value (denoted TSQM1), and a second total speech quality measure value (denoted TSQM2), where TSQM1 represents a measure of the local ambient background noise at the first terminal device 200a and of the current network conditions between the first terminal device 200a and the second terminal device 200b, and TSQM2 represents a measure of the local ambient background noise at the second terminal device 200b and of the current network conditions between the first terminal device 200a and the second terminal device 200b. In this respect, the first terminal device 200a might include both the input speech and the input noise (if there is any). This means that the second terminal device 200b might estimate the ambient noise at the first terminal device 200a, which then might be included in TSQM2. The indication might then be that the speech signal is to be the text signal when TSQM1 is more than a second threshold value larger than TSQM2 and otherwise to be an encoded speech signal of the speech signal. As the skilled person understands, there are several ways for how different types quality enhancement factors and different types of distortions can be combined into a TSQM, thus impacting whether the speech signal is to be the text signal or to be an encoded speech signal of the speech signal. Further aspects relating thereto will be disclosed below.

In some embodiments the indication of whether the first terminal device 200a is to convert the speech signal to the text signal or not is obtained by being determined by the network node 300. In other embodiments the indication of whether the first terminal device 200a is to convert the speech signal to the text signal or not is obtained by being received from the first terminal device 200a or from the second terminal device 200b.

As above, in some embodiments the indication of whether the first terminal device 200a is to convert the speech signal to the text signal or not is received in an SDP message. As above, in some embodiments the indication provided to the first terminal device 200a is provided in an SDP message.

Embodiments, aspects, scenarios, and examples relating to the first terminal device 200a, the second terminal device 200b, as well as the network node 300 (where applicable) will be disclosed next.

Further aspects of the TSQM will be disclosed next. As above, each TSQM value is based on a measure of the local ambient background noise at either or both of the first terminal device 200a and the second terminal device 200b. Furthermore, the TSQM may also be based on the current network conditions between the first terminal device 200a and the second terminal device 200b.

For example, each TSQM value could be determined according to any of the following expressions.

TSQM=function(“ambient background noise level”, “radio”),

TSQM=function{function1(“ambient background noise level”), function2(“radio”)},

TSQM=function1(“ambient background noise level”)+function2(“radio”).

Here “radio” represents the network conditions and could be determined in terms of one or more of RSRP, SINR, RSRQ, UE Tx power, PLR, (HARQ) BLER, FER, etc. The network conditions might further represent other transport-related performance metrics such as packet losses in a fixed transport network, packet losses caused by buffer overflow in routers, late losses in the second terminal device 200b caused by large jitter; etc. Further, “ambient background noise level” refers either to the local ambient background noise level at the first terminal device 200a, the ambient background noise level at the second terminal device 200b, or a combination thereof. The terms “function”, “function1”, and “function2” represent any suitable function for estimating sound quality or network conditions, as applicable.

As above, a comparison of the TSQM value can be made to a first threshold value, and if below the first threshold value, the representation of the speech signal is determined to be the text signal. As above, the TSQM value might be determined by the first terminal device 200a, the second terminal device 200b, or the network node 300, as applicable. The comparison of the TSQM value to the first threshold value might be performed in the same device as computed the TSQM value or might be performed in another device where the device in which the TSQM value has been computed signals the TSQM value to the device where the comparison to the first threshold is to be made.

As above, a comparison of the difference between two TSQM values (TSQM1 and TSQM2) can be made to a second threshold value, and if the two TSQM values differ more than the second threshold value, the representation of the speech signal is determined to be the text signal. As above, the TSQM values might be determined by the first terminal device 200a, the second terminal device 200b, or the network node 300, as applicable. The comparison of the TSQM values to the second threshold value might be performed in the same device as computed the TSQM values or might be performed in another device where the device in which the TSQM values has been computed signals the TSQM values to the device where the comparison to the first threshold is to be made. Yet alternatively, the TSQM1 value is computed in a first device, the TSQM2 value is computed in a second device, and the comparison is made in the first device, the second device, or in a third device.

Examples of application in which the herein disclosed embodiments can be applied will now be disclosed. However, as the skilled person understands, these are just some examples and the herein disclosed embodiment could be applied to other applications as well.

As a first application, in scenarios where the first terminal device 200a and the second terminal device 200b are configured for push to talk (PTT), where real-time requirements are relaxed, transcribed text could always be sent in parallel to the PTT voice call, the text signal thus being provided to all terminal devices in the PIT group.

As a second application, in scenarios where speech to text conversion is executed, the second terminal device 200b might have different benefits of the received text signal given current circumstances. For example, assuming that the second terminal device 200b is equipped with a headset having a display for playing out the text, or is operatively connected to such a headset, the user of the second terminal device 200b could benefit either from having the content read-out (transcribed text to speech) or presented as text when network conditions are poor and/or when there is a high local ambient background noise level at the second terminal device 200b. In such scenarios the text signal can be played out to the display in parallel with the audio signal (if available) being played out to a loudspeaker at the second terminal device 200b or to a headphone (either provided separately or as part of the aforementioned headset) operatively connected to the second terminal device 200b. Alternatively, the text signal is not played out to the display in parallel with the audio signal, for example either after the audio signal having been played out, or after the audio signal has been played out; the case where the audio signal is not played out at all is covered below.

As a third application, in scenarios where the use of a headset as in the second scenario is prohibited, for example due to power shortage in the headset or because of legal restrictions, the user of the second terminal device 200b could be prompted by a text message notifying that the text signal will be played out locally at a built-in display at the second terminal device 200b or that the user might request that the speech signal instead is played out (only) as audio.

As a fourth application, in scenarios where the user of the second terminal device 200b would not benefit from the speech signal being played out as text, the user might, via a user interface, provide instructions to the second terminal device 200b that the speech signal is not to be played out as text but as audio. In case the representation of the speech signal as received at the second terminal device 200b is a text signal the second terminal device 200b will then perform a text to speech conversation before playing out the speech signal as audio.

As a fifth application, in scenarios where the network conditions change and/or where the local ambient background noise level changes at the first terminal device and/or the second terminal device 200b, the representation at which the speech signal is transmitted and/or played out might change during an ongoing communication session. The user might be explicitly notified of such a change by, for example, a sound, a dedicated text message, or a vibration, being played out at the second terminal device 200b.

Different scenarios where the first terminal device 200a, the second terminal device 200b, and/or the network node 300 hold certain pieces of information regarding network conditions and local ambient background noise are illustrated in Table 1. In Table 1, the transcription action “TranscriptionON” represent the case where the speech signal is converted to a text signal and thus where the representation is a text signal, and the transcription action “TranscriptionOFF” represent the case where the speech signal is not converted to a text signal and thus where the representation is an encoded speech signal. In Table 1, the first terminal device 200a is represented by the sender, the second terminal device 200b is represented by the receiver, and the network node 300 is represented by the network (denoted NW).

TABLE 1
Transcription alternatives depending on local ambient
background noise levels and network conditions.

| | | | | Transcription actions |
|---|---|---|---|---|
| Receiver | Network | Sender | | ON, OFF, |
| ambient | status; | ambient | Description of | active parties |
| noise | network | noise | communication | (receiver, sender, |
| level | conditions | level | situation | network), etc. |
| High | Good | High | Receiver | • Receiver requests |
| | | | side would | TranscriptionON to |
| | | | benefit from | the network |
| | | | transcribed text | • Network forwards |
| | | | despite good | TranscriptionON to |
| | | | network | sender's device |
| | | | conditions. | • Sender's device |
| | | | Sender also | enables |
| | | | has high | transcription and send |
| | | | ambient noise | transcribed text to |
| | | | levels, and | network |
| | | | will transcribes | |
| | | | speech to text | |
| | | | anyhow (since | |
| | | | listener | |
| | | | will suffer | |
| | | | independently | |
| | | | from | |
| | | | receiver's | |
| | | | ambient noise | |
| | | | and/or NW | |
| | | | quality) | |
| High | Poor | High | Troubles at both | • Receiver requests |
| | | | sides and | TranscriptionON to |
| | | | in network | the network |
| | | | conditions too. | • NW detects network |
| | | | All nodes might | conditions impacts |
| | | | request support | and triggers |
| | | | by transcriptions. | own desire for |
| | | | Preferable | transcription, |
| | | | if network | NW could as |
| | | | node coordinates | well fetch receiver's |
| | | | request for | device request for |
| | | | transcriptions | transcription; anyhow |
| | | | | network forwards |
| | | | | TranscriptionON to |
| | | | | sender's device |
| | | | | • Sender's device |
| | | | | enables |
| | | | | transcription and send |
| | | | | transcribed text to |
| | | | | network |
| High | Good | Low | Receiver has | • Receiver requests |
| | | | hard time to | TranscriptionON to |
| | | | hear anything | the network |
| | | | despite | •Network forwards |
| | | | good network | TranscriptionON to |
| | | | conditions and | sender's device or |
| | | | no noise | enables transcription |
| | | | at the sender's | itself |
| | | | side | •If network forwards |
| | | | | the TranscriptionON |
| | | | | request to the |
| | | | | sender's device, then |
| | | | | the sender's device |
| | | | | enables transcription |
| High | Poor | Low | Both high | • Receiver requests |
| | | | ambient | TranscriptionON to |
| | | | noise at | the network due |
| | | | the receiver | to high noise |
| | | | side and poor | • NW either |
| | | | network | understands NW |
| | | | conditions | quality impacts and |
| | | | demands | triggers own |
| | | | transcription | desire for |
| | | | to text for | transcription; anyhow |
| | | | the receiver. | network forwards |
| | | | Low noise | TranscriptionON to |
| | | | at sender | sender's device |
| | | | side, which not | • Sender's device |
| | | | trigger | either turns |
| | | | anything... | transcription (or |
| | | | | according given |
| | | | | always-on |
| | | | | scenario only) |
| | | | | forwarded by |
| | | | | network |
| Low | Good | High | Sender device | • Neither receiver, |
| | | | transcribes | nor network |
| | | | speech to text | perceive any |
| | | | (listener will in | problems, and |
| | | | either | will not |
| | | | way suffer | trigger any |
| | | | independently | transcription |
| | | | from | • Sender's device |
| | | | good/bad own | detects high |
| | | | ambient noise | ambient noise and |
| | | | levels | turns transcription on; |
| | | | and/or network | sending device also |
| | | | quality) | notifies NW of its |
| | | | | conditions (given that |
| | | | | sender has |
| | | | | not received |
| | | | | any request directly |
| | | | | from network nor |
| | | | | forwarded originally |
| | | | | from receiver) |
| | | | | • NW receives said |
| | | | | notification from |
| | | | | sender (along with the |
| | | | | transcribed content) |
| | | | | • Network forwards |
| | | | | transcribed content to |
| | | | | receiver |
| Low | Good | Low | Low noise | • Sender could have |
| | | | at both | transcription on |
| | | | receiver and | and send |
| | | | sender side, | it to network, whereas |
| | | | good NW | the network by some |
| | | | quality. | internal trigging (for |
| | | | No need for | some other purpose) |
| | | | transcription at | desires to have said |
| | | | R/S sides | transcribed content |
| | | | | available |
| | | | | • Network could |
| | | | | likewise trigger |
| | | | | sending side to |
| | | | | turn on/provide |
| | | | | transcribed content as |
| | | | | a function of some |
| | | | | internal trigger |
| | | | | • If transcription was |
| | | | | previously enabled, |
| | | | | then Transcription- |
| | | | | OFF maybe |
| | | | | sent to the disable |
| | | | | transcription |
| Low | Poor | High | Sender | • Receiver has |
| | | | cannot know | low noise |
| | | | anything about | levels and will not by |
| | | | resulting | itself trigger any |
| | | | quality at | transcription |
| | | | the sender's | • Network detects |
| | | | side or in | poor network |
| | | | the network | conditions and |
| | | | | requests sending |
| | | | | device to |
| | | | | turn on transcription |
| | | | | • If network receives |
| | | | | transcribed content |
| | | | | from sender, |
| | | | | it could discard |
| | | | | own request to |
| | | | | sender, but |
| | | | | sender could benefit |
| | | | | from info “not only |
| | | | | poor quality due to |
| | | | | your noise levels” |
| | | | | • Sending |
| | | | | device sends |
| | | | | transcribed content |
| Low | Poor | Low | Troubles | • Network detects |
| | | | arise from | poor radio conditions |
| | | | poor network | • Network sends |
| | | | conditions; | TranscriptionON to |
| | | | neither | sender's device |
| | | | receiving/ | • Receiver-side, |
| | | | sending | see above |
| | | | device | • Network can |
| | | | detect any | decide to forward |
| | | | noise issues | or not forward |
| | | | Transcription | the transcribed text to |
| | | | always-on | receiving device |
| | | | in sending | depending on request, |
| | | | device | or depending on poor |
| | | | | network conditions |
| | | | | • Alternatively, |
| | | | | to always have |
| | | | | speech to text |
| | | | | transcription always- |
| | | | | on in sending device |

Further aspects of signalling between the first terminal device 200a, the second terminal device 200b, and/or the network node 300 will now be disclosed.

Which functionality that should be performed by, or executed in, each respective device (i.e., the first terminal device 200a, the second terminal device 200b, and the network node 300) might be negotiated between the involved entities. Such negotiation may be performed at communication session setup or during an ongoing communication session. As noted above, in some examples, communication between the first terminal device 200a and the second terminal device 200b is facilitated by means of SDP messages. The SDP messages might be sent with the Session Initiation Protocol (SIP). For example, the SDP messages might be based on an offer/answer model as specified in RFC 3264: “An Offer/Answer Model with the Session Description Protocol (SDP)” by The Internet Society, June 2002, as available here: https://tools.ietf.org/html/rfc3264. Other ways of facilitating the communication between the first terminal device 200a and the second terminal device 200b might also be used.

During a set-up of a point-to-point Voice of the Internet Protocol (VoIP) session the originating end-point (i.e., either first terminal device 200a or the second terminal device 200b) sends an SDP offer message to propose a couple of alternative media types and codecs and the terminating end-point (i.e., the other of the first terminal device 200a and the second terminal device 200b) receives the SDP offer message, selects which media types and codecs to use, and then sends an SDP answer message back towards the originating end-point. The SDP offer might be sent in a SIP INVITE message or in a SIP UPDATE message. The SDP answer message might be sent in a 200 OK message or in a 100 TRYING message.

As above, SDP attributes ‘TranscriptionON’ and ‘TranscriptionOFF’ might be defined for identifying that the speech signal could be transmitted as a text signal and whether this functionality is enabled or disabled. This attribute might be transmitted already with the SDP offer message or the SDP answer message at the set-up of the VoIP session. If conditions necessitate a change of the representation of the speech signal as transmitted from the first terminal device 200a to the second terminal device 200b, a further SDP offer message or SDP answer message comprising the corresponding SDP attribute ‘TranscriptionON’ or ‘TranscriptionOFF’ might be sent.

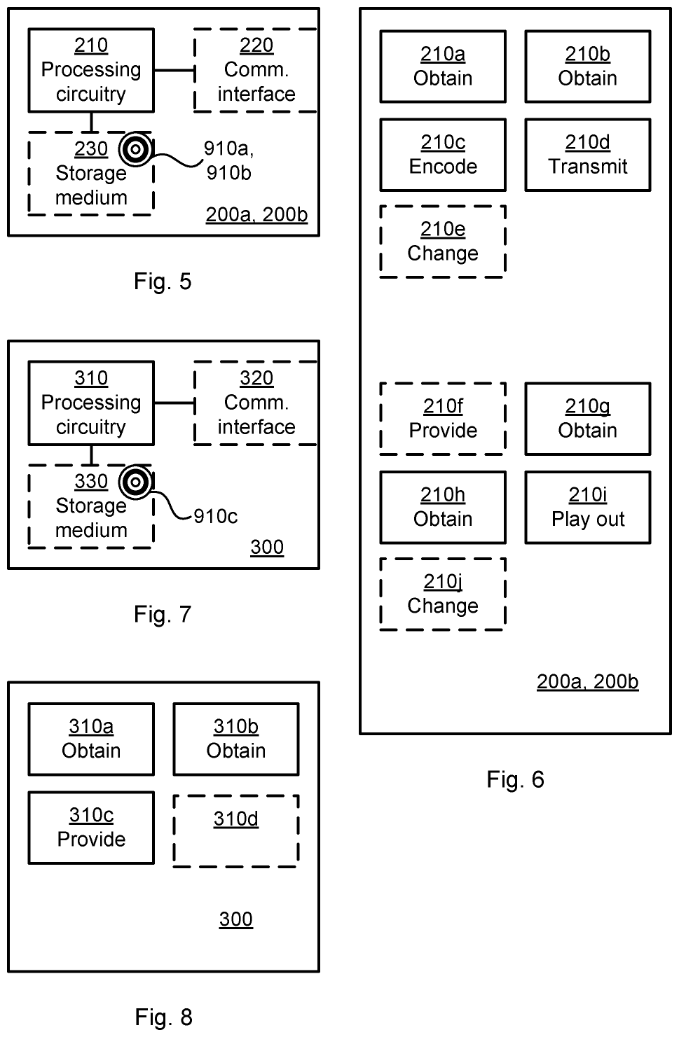

FIG. 5 schematically illustrates, in terms of a number of functional units, the components of a terminal device 200a, 200b according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910a (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the terminal device 200a, 200b to perform a set of operations, or steps, as disclosed above. For example, the storage medium 230 may store the set of operations, and the processing circuitry 210 may be configured to retrieve the set of operations from the storage medium 230 to cause the terminal device 200a, 200b to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The terminal device 200a, 200b may further comprise a communications interface 220 for communications with other entities, nodes functions, and devices, such as another terminal device 200a, 200b and/or the network node 300. As such the communications interface 220 may comprise one or more transmitters and receivers, comprising analogue and digital components.

The processing circuitry 210 controls the general operation of the terminal device 200a, 200b e.g. by sending data and control signals to the communications interface 220 and the storage medium 230, by receiving data and reports from the communications interface 220, and by retrieving data and instructions from the storage medium 230. Other components, as well as the related functionality, of the terminal device 200a, 200b are omitted in order not to obscure the concepts presented herein.

FIG. 6 schematically illustrates, in terms of a number of functional modules, the components of a terminal device 200a, 200b according to an embodiment.

The terminal device of FIG. 6 when configured to operate as the first terminal device 200a comprises an obtain module 210a configured to perform step S102, an obtain module 210b configured to perform step S104, an encode module 210c configured to perform step S106, and a transmit module 210d configured to perform step S108. The terminal device of FIG. 6 when configured to operate as the first terminal device 200a may further comprise a number of optional functional modules, such as a change module 210e configured to perform step S110.

The terminal device of FIG. 6 when configured to operate as the second terminal device 200b comprises an obtain module 210g configured to perform step S204, an obtain module 210h configured to perform step S206, and a play out module 210i configured to perform step S208. The terminal device of FIG. 6 when configured to operate as the second terminal device 200b may further comprise a number of optional functional modules, such as any of a provide module 210f configured to perform step S202, and a change module 210j configured to perform step S210.

As the skilled person understands, one and the same terminal device might selectively operate as either a first terminal device 200a and a second terminal device 200b.

In general terms, each functional module 210a-210j may be implemented in hardware or in software. Preferably, one or more or all functional modules 210a-210j may be implemented by the processing circuitry 210, possibly in cooperation with the communications interface 220 and/or the storage medium 230. The processing circuitry 210 may thus be arranged to from the storage medium 230 fetch instructions as provided by a functional module 210a-210j and to execute these instructions, thereby performing any steps of the terminal device 200a, 200b as disclosed herein.

FIG. 7 schematically illustrates, in terms of a number of functional units, the components of a network node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 910b (as in FIG. 9), e.g. in the form of a storage medium 330. The processing circuitry 310 may further be provided as at least one application specific integrated circuit (ASIC), or field programmable gate array (FPGA).

Particularly, the processing circuitry 310 is configured to cause the network node 300 to perform a set of operations, or steps, as disclosed above. For example, the storage medium 330 may store the set of operations, and the processing circuitry 310 may be configured to retrieve the set of operations from the storage medium 330 to cause the network node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The network node 300 may further comprise a communications interface 320 for communications with other entities, nodes functions, and devices, such as the terminal devices 200a, 200b. As such the communications interface 320 may comprise one or more transmitters and receivers, comprising analogue and digital components.

The processing circuitry 310 controls the general operation of the network node 300 e.g. by sending data and control signals to the communications interface 320 and the storage medium 330, by receiving data and reports from the communications interface 320, and by retrieving data and instructions from the storage medium 330. Other components, as well as the related functionality, of the network node 300 are omitted in order not to obscure the concepts presented herein.

FIG. 8 schematically illustrates, in terms of a number of functional modules, the components of a network node 300 according to an embodiment. The network node 300 of FIG. 8 comprises a number of functional modules; an obtain module 310a configured to perform step S302, an obtain module 310b configured to perform step S304, and a provide module 310c configured to perform step S306. The network node 300 of FIG. 8 may further comprise a number of optional functional modules, as symbolized by functional module 310d. In general terms, each functional module 310a-310d may be implemented in hardware or in software. Preferably, one or more or all functional modules 310a-310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a-310d and to execute these instructions, thereby performing any steps of the network node 300 as disclosed herein.

The network node 300 may be provided as a standalone device or as a part of at least one further device. For example, the network node 300 may be provided in a node of the radio access network or in a node of the core network. Alternatively, functionality of the network node 300 may be distributed between at least two devices, or nodes.

These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network node 300 may be executed in a first device, and a second portion of the instructions performed by the network node 300 may be executed in a second device; the herein disclosed embodiments are not limited to any particular number of devices on which the instructions performed by the network node 300 may be executed. Hence, the methods according to the herein disclosed embodiments are suitable to be performed by a network node 300 residing in a cloud computational environment. Therefore, although a single processing circuitry 210 is illustrated in FIG. 7 the processing circuitry 310 may be distributed among a plurality of devices, or nodes. The same applies to the functional modules 310a-310d of FIG. 8 and the computer programs 920c of FIG. 9.

FIG. 9 shows one example of a computer program product 910a, 910b, 910c comprising computer readable means 930. On this computer readable means 930, a computer program 920a can be stored, which computer program 920a can cause the processing circuitry 210 and thereto operatively coupled entities and devices, such as the communications interface 220 and the storage medium 230, to execute methods according to embodiments described herein. The computer program 920a and/or computer program product 910a may thus provide means for performing any steps of the first terminal device 200a as herein disclosed. On this computer readable means 930, a computer program 920b can be stored, which computer program 920b can cause the processing circuitry 310 and thereto operatively coupled entities and devices, such as the communications interface 320 and the storage medium 330, to execute methods according to embodiments described herein. The computer program 920b and/or computer program product 910b may thus provide means for performing any steps of the second terminal device 200b as herein disclosed. On this computer readable means 930, a computer program 920c can be stored, which computer program 920c can cause the processing circuitry 910 and thereto operatively coupled entities and devices, such as the communications interface 920 and the storage medium 930, to execute methods according to embodiments described herein. The computer program 920c and/or computer program product 910c may thus provide means for performing any steps of the network node 300 as herein disclosed.

In the example of FIG. 9, the computer program product 910a, 910b, 910c is illustrated as an optical disc, such as a CD (compact disc) or a DVD (digital versatile disc) or a Blu-Ray disc. The computer program product 910a, 910b, 910c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920a, 920b, 920c is here schematically shown as a track on the depicted optical disk, the computer program 920a, 920b, 920c can be stored in any way which is suitable for the computer program product 910a, 910b, 910c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

### ABBREVIATIONS

ACR Absolute Category Rating
ARQ Automatic Repeat reQuest
BLER BLock Error Rate
DCR Degradation Category Rating
DMOS Degradation MOS
FER Frame Erasure Rate
HARQ Hybrid ARQ
MOS Mean Opinion Score
PLR Packet Loss Rate
PIT Push-to-Talk (i.e. walkie talkie)
RSRP Reference Signal Receiver Power
RSRQ Reference Signal Received Quality
SINR Signal to Interference and Nosie Ratio
SQI Speech Quality Index
VoIP Voice over IP

1. A method for transmitting a representation of a speech signal to a second terminal device, the method being performed by a first terminal device, the method comprising:
obtaining a speech signal to be transmitted to the second terminal device;
obtaining an indication of whether to, when encoding the speech signal into the representation, convert the speech signal to a text signal or not before transmission to the second terminal device, the indication being based on information of local ambient background noise at the first terminal device and of current network conditions between the first terminal device and the second terminal device;
encoding the speech signal into the representation of the speech signal as determined by the indication; and
transmitting the representation of the speech signal towards the second terminal device.

2. The method according to claim 1, wherein the speech signal is only encoded to an encoded speech signal when the indication is to not convert the speech signal to the text signal before transmission.

3. The method according to claim 1, wherein the speech signal is encoded to an encoded speech signal regardless if the encoding involves converting the speech signal to the text signal or not.

4. The method according to claim 3, wherein the representation comprises both the text signal and the encoded speech signal of the speech signal such that the text signal and the encoded speech signal are transmitted in parallel.

5. The method according to claim 1, wherein the information is represented by a total speech quality measure, TSQM, value, and wherein the representation of the speech signal is determined to be the text signal when the TSQM value is below a first threshold value and otherwise to be an encoded speech signal of the speech signal.

6. The method according to claim 1, wherein the information is represented by a first total speech quality measure value, TSQM1, and a second total speech quality measure value, TSQM2, wherein TSQM1 represents a measure of the local ambient background noise at the first terminal device and of the current network conditions between the first terminal device and the second terminal device, wherein TSQM2 represents a measure of local ambient background noise at the second terminal device and of the current network conditions between the first terminal device and the second terminal device, and wherein the representation of the speech signal is determined to be the text signal when TSQM1 is more than a second threshold value larger than TSQM2 and otherwise to be an encoded speech signal of the speech signal.

7. The method according to claim 1, wherein the indication is obtained by being determined by the first terminal device.

8. The method according to claim 1, wherein the indication is obtained by being received from the second terminal device or from a network node serving at least one of the first terminal device and the second terminal device.

9. The method according to claim 8, wherein the indication is received in an SDP message.

10. The method according to claim 9, wherein the SDP message is an SDP offer by with an attribute having a binary value defining whether to convert the speech signal to a text signal or not.

11. The method according to claim 1, wherein the indication further is based on information of local ambient background noise at the second terminal device.

12. The method according to claim 1, wherein the representation of the speech signal is transmitted during a communication session between the first terminal device and the second terminal device, the method further comprising:
changing the encoding of the speech signal during the communication session.

13-24. (canceled)

25. A method for handling transmission of a representation of a speech signal from a first terminal device to a second terminal device, the method being performed by a network node, the method comprising:
obtaining an indication that the speech signal is to be transmitted from the first terminal device to the second terminal device;
obtaining an indication of whether the first terminal device is to, when encoding the speech signal into the representation, convert the speech signal to a text signal or not before transmission to the second terminal device, the indication being based on information of current network conditions between the first terminal device and the second terminal device and at least one of local ambient background noise at the first terminal device and local ambient background noise at the second terminal device; and
providing the indication of whether the first terminal device is to convert the speech signal to a text signal or not before transmission to the second terminal device to the first terminal device.

26. The method according to claim 25, wherein the information is represented by a total speech quality measure, TSQM, value, and wherein the indication is that the representation of the speech signal is to be the text signal when the TSQM value is below a first threshold value and otherwise to be an encoded speech signal of the speech signal.

27. The method according to claim 25, wherein the information is represented by a first total speech quality measure value, TSQM1, and a second total speech quality measure value, TSQM2, wherein TSQM1 represents a measure of the local ambient background noise at the first terminal device and of the current network conditions between the first terminal device and the second terminal device, wherein TSQM2 represents a measure of the local ambient background noise at the second terminal device and of the current network conditions between the first terminal device and the second terminal device, and wherein the indication is that the speech signal is to be the text signal when TSQM1 is more than a second threshold value larger than TSQM2 and otherwise to be an encoded speech signal of the speech signal.

28. The method according to claim 25, wherein the indication of whether the first terminal device is to convert the speech signal to the text signal or not is obtained by being determined by the network node.

29. The method according to claim 25, wherein the indication of whether the first terminal device is to convert the speech signal to the text signal or not is obtained by being received from the first terminal device or from the second terminal device.

30. The method according to claim 29, wherein the indication of whether the first terminal device is to convert the speech signal to the text signal or not is received in an SDP message.

31. (canceled)

32. A first terminal device for transmitting a representation of a speech signal to a second terminal device, the first terminal device comprising processing circuitry, the processing circuitry being configured to cause the first terminal device to:
obtain a speech signal to be transmitted to the second terminal device;
obtain an indication of whether to, when encoding the speech signal into the representation, convert the speech signal to a text signal or not before transmission to the second terminal device, the indication being based on information of local ambient background noise at the first terminal device and of current network conditions between the first terminal device and the second terminal device;
encode the speech signal into the representation of the speech signal as determined by the indication; and
transmit the representation of the speech signal towards the second terminal device.

33. (canceled)

34. A network node for handling transmission of a representation of a speech signal from a first terminal device to a second terminal device, the network node comprising processing circuitry, the processing circuitry being configured to cause the network node to:
obtain an indication that the speech signal is to be transmitted from the first terminal device to the second terminal device;
obtain an indication of whether the first terminal device is to, when encoding the speech signal into the representation, convert the speech signal to a text signal or not before transmission to the second terminal device, the indication being based on information of current network conditions between the first terminal device and the second terminal device and at least one of local ambient background noise at the first terminal device and local ambient background noise at the second terminal device; and
provide the indication to the first terminal device.

35-38. (canceled)
